(19) United States
(12) Patent Application Publication
(10) Pub. No.: US 2011/0060721 A1
(43) Pub. Date: Mar. 10, 2011

(54) OFFLINE DOWNLOADER

(75) Inventors: Olivier Chalouhi, Redwood City, CA (US); Paul Anton Richardson Gardner, Palo Alto, CA (US)

(73) Assignee: Vuze, Inc., San Mateo, CA (US)

(21) Appl. No.: 12/853,963

(22) Filed: Aug. 10, 2010

Related U.S. Application Data
(60) Provisional application No. 61/232,668, filed on Aug. 10, 2009.

(51) Int. Cl. G06F 17/00

(52) U.S. Cl. 707/622; 707/E17.032

(57) ABSTRACT

In a method and system for facilitating peer-to-peer networking, a download set identifying content being downloaded by a client program is transmitted to a network device. In response to an offline event indicating that the client program is no longer downloading the content over a network, an online event indicating the client program is resuming the downloading of the content is transmitted to the network device. Downloading of the content identified by the download set is completed by synchronizing the client program with the network device.

### RELATED APPLICATIONS

This patent application claims the benefit of priority, under 35 U.S.C. §119(e), to U.S. Provisional Patent Application Ser. No. 61/232,668, filed on Aug. 10, 2009, which is incorporated herein by reference in its entirety.

### TECHNICAL FIELD

Example embodiments relate generally to peer-to-peer (P2P) file transfers over a network (e.g., the Internet).

### BACKGROUND

BitTorrent is currently one of the most popular methods of distributing large files over the Internet. For a given file, the BitTorrent protocol embodies four main roles: an initial seeder, new seeders, a tracker, and peers. Initial seeders, new seeders, and peers are all transient clients, while the tracker is typically a server. The initial seeder is the source of the file, and operates by dividing a file into small pieces, creating a metadata description of the file and sending this description to a tracker. Peers discover this file metadata description, usually as a .torrent file, through an out-of-band mechanism (e.g., a web page) and then begin looking for pieces of the file. Peers contact a central tracker to bootstrap their knowledge of other peers and seeds, and the tracker returns a randomized subset of other peers and seeds. Initially, only the initial seeder has pieces of a file, but soon peers are able to exchange missing pieces with each other. Once a peer acquires all of the pieces of a file, it becomes a new seeder. This collection of clients actively sharing a file is called a swarm.

In some client-based peer-to-peer (P2P) systems (e.g., the VUZE® client developed by Vuze, Inc. of Palo Alto, Calif.), file descriptors and other metadata are stored in a distributed hash table (DHT), in which all clients participate, and any node can be assigned the role of tracker if its unique identification number is equal or close to the hash of a given file's descriptor. This is mainly used as a backup mechanism when the original tracker is offline or otherwise not responding to requests for the file. However, the DHT is also a way to distribute a file without a central tracker at all or to locate additional peers that are not connected to a tracker.

### BRIEF DESCRIPTION OF DRAWINGS

FIG. 1 is a block diagram illustrating a peer-to-peer (P2P) networking environment, within which a P2P client program connects, via a network, with P2P client programs and a P2P tracker program, according to an example embodiment.

FIG. 2A is a block diagram showing an example of a transition of control of a content download between a P2P client program and a P2P offline program, according to an example embodiment.

FIG. 2B is a block diagram showing an example of a transition of control of a content download between a P2P client program and a P2P offline program, according to an example embodiment.

FIG. 2C is a block diagram showing an example of a transition of control of a content download between a P2P client program and a P2P offline program, according to an example embodiment.

FIG. 3 is a block diagram showing modules of a P2P client program, running on a client machine, and modules of a P2P offline program, running on a network device, according to an example embodiment.

FIG. 4 is a flowchart illustrating an example method of enabling a network device to perform offline downloading.

FIG. 5 is a flowchart illustrating an example method of updating a network device with download status of content being downloaded by a client P2P program.

FIG. 6 is a flowchart illustrating an example method of sending an online event from a P2P client program to a P2P offline program.

FIG. 7 is a flowchart that illustrates an example method of determining a download action for a network device based on an active mode.

FIG. 8 is a block diagram illustrating an example embodiment of multiple client machines communicating over the network via the networking device to download content.

FIG. 9 shows a diagrammatic representation of a machine in the example form of a computer system.

### DETAILED DESCRIPTION

In the following description, for purposes of explanation, numerous specific details are set forth in order to provide a thorough understanding of the claimed subject matter. It will be evident, however, to one skilled in the art that the claimed subject matter may be practiced without these specific details.

To continue a data download even while a client P2P program is not available, the client P2P program may configure a network device (e.g., a router) to assume control over a data download based on an occurrence of an offline event. Once configured, the networking device may receive status updates from the client P2P client program. The status updates may include an indication of those pieces of a download needed by the client P2P program. Responsive to an offline event, the network device may switch to active mode. While in the active mode, the network device continues downloading the content download initiated by the client P2P client program. Responsive to an online event, the network device may synchronize with the client P2P program by transferring pieces of the content downloaded by the network device.

An offline event may be an event that indicates that a network device should assume control over a data download. In an example embodiment, an offline event can indicate that the P2P client program has been disconnected from a P2P swarm. In an example embodiment, the data download may be a bit torrent download, and the P2P swarm may be a bit torrent swarm. For example, the P2P client program may be disconnected from the P2P swarm based on the client machine shutting down or being placed on standby, or the P2P client program being closed out. In other example embodiments, an offline event may indicate that the P2P client program explicitly requests the network device to assume control over the download. For example, the P2P client program may schedule offline downloading during periods where the resources of the client machine are used most (e.g., during the work day, morning, afternoons, evenings, or other time period). The P2P may schedule offline downloading either by a predetermined schedule or by monitoring the use of the client machine.

An online event may be an event that indicates that the P2P client program should resume control over a data download. In an example embodiment, an online event can indicate that the P2P client program has reconnected to a P2P swarm. For example, the P2P client program may be connected to the swarm based on the client machine booting up or being taken out of standby mode, or based on the P2P client program being opened by a user operating the client machine.

A network device may be a device that participates in the download between the peers uploading the content file and the peer downloading the content file. That is, the network device may be a device located along the path between the uploading and downloading peers. The network device may be a router or other internet gateway device (as may be included or may be an extension of: http://www.upnp.org/standardizeddcps/documents/upnp_igd_internetgatewaydevice%20 1.0.pdf).

A client P2P program may be an application that downloads content from other client P2P programs. An example of a client P2P program is a bit torrent client program (e.g., the VUZE® client program) that distributes content according to the BitTorrent protocol. In an example embodiment, the client P2P program may download and upload content from the swarm. In other example embodiments, the client P2P program may download content from multiple peers or seeders.

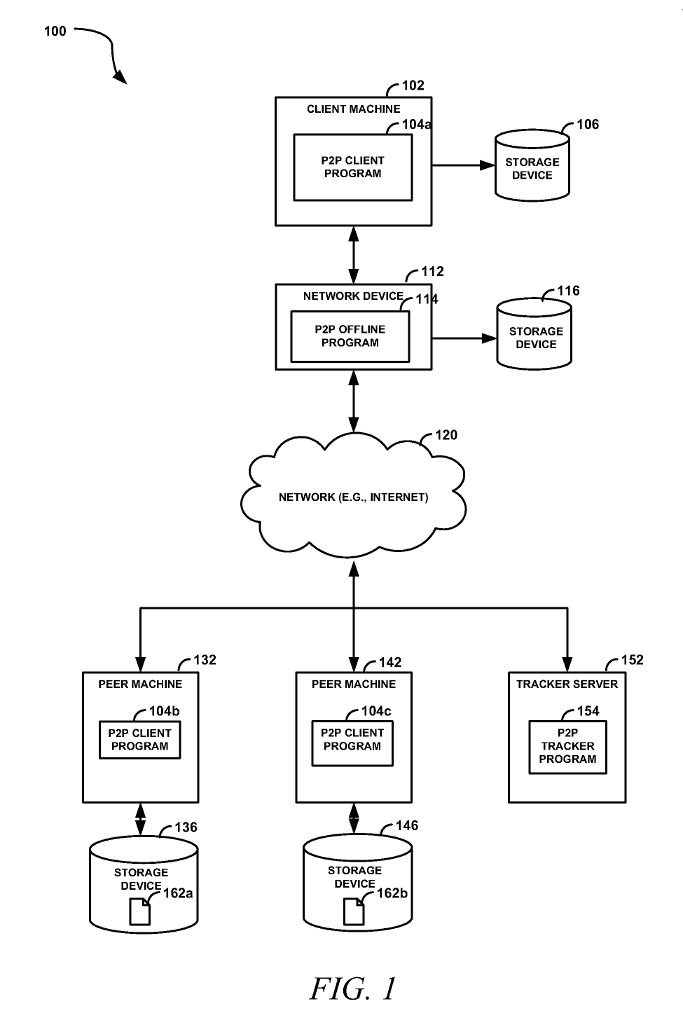

FIG. 1 is a block diagram illustrating an example peer-to-peer (P2P) networking environment 100 within which a P2P client program 104a connects, via a network 120, with P2P client programs 104b and 104c and a P2P tracker program 154. Collectively, the P2P client programs 104a-c represent a P2P swarm (referred to as 104). The P2P swarm 104 distributes content 162a-b (collectively referred to as 162).

The P2P client program 104a runs on a client machine 102. The client machine 102 connects to the network 120 and communicates with the swarm 104 via the network device 112. The client machine 102 is connected to a storage device 106 to store pieces of the file 162 received by the swarm 104.

The network device 112 includes a P2P off-line program 114. The P2P off-line program 114 coordinates with the P2P client program 104a to facilitate continued downloading of the content 162 when the P2P client program 104a is offline (e.g., disconnected from the swarm 104). The network device 112 also is connected to a storage device 116 to store pieces of the content 162 downloaded while the client P2P program 104a is offline. The network device 112 may be a router or other internet gateway device. In an example embodiment, the network device 112 assumes control over the download of the content 162 responsive to receiving an offline event, such as, for example, an indication that the P2P client program 104a is no longer connected to the swarm 104.

P2P client programs 104b and 104c are peers that are run on peer machine 132 and 142. Each peer machine 132 and 142 is connected to a storage device (e.g., 136 and 146) that stores local pieces of the content 162, in whole or in part. In a BitTorrent system, P2P client programs 104b and 104c may be seeders, peers, or some combination thereof. As described above, a peer downloading the content 162 also may become a source of those pieces of the file 162 just received. Additionally, further peers may join the swarm 104, further increasing the number of peers sending and receiving pieces of the file 162 being distributed to the P2P client program 104a.

The P2P tracker program 154 runs on a tracker server 152. The P2P tracker program 154 stores a list of peers, with connection information, within the swarm 104 which can be requested for pieces of the content 162. In other example embodiments, the swarm 104 may distribute peer information via a distributed hash table (DHT).

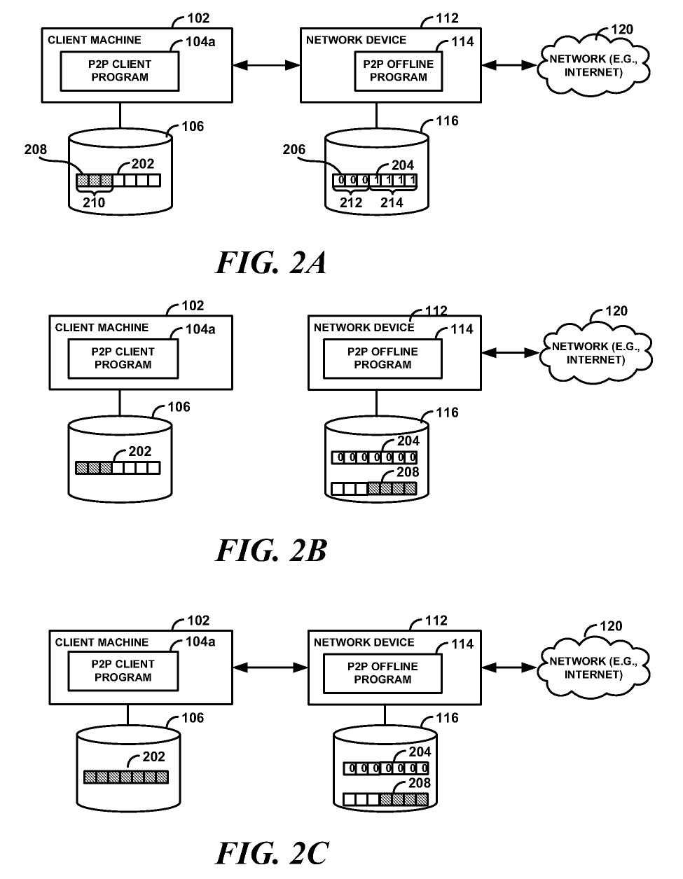

FIGS. 2A-2C are block diagrams showing example embodiments of a transition of control of a download of a content 202 between the P2P client program 104a and the P2P offline program 114. Each of FIGS. 2A-C, represents a respective point in time during the transition of control, in which the content 202 is being downloaded.

As was shown in FIG. 1, FIG. 2A shows the client machine 102 communicating over the network 120 via the networking device 112 to download content 202 stored in data storage 106. At a first point in time, as FIG. 2A shows, the P2P client program 104a has downloaded three pieces of the content 202, as indicated by a shaded region 210. Additionally, the P2P offline program 114 records status of the download of the content 202, as may be communicated from the P2P client program. For example, a reverse bit field 204 may indicate the pieces of the content 202 that are still needed by the P2P client program 104a to complete the download. The reverse bit field 204 includes elements that map to particular pieces of the content 202. For example, the first element 206 of the reverse bit field 204 may map to the first piece 208 of the content 202.

In an example embodiment, an element of the reverse bit-field 204 may store a value of 0 to indicate that the corresponding piece of the content 202 is not required. Further, an element of the reverse bit-field 204 stores a value of 1 to indicate that a corresponding piece of the content 202 is required to complete the download. Because the P2P client program 204a has, as of the point of time shown in FIG. 2A, downloaded the pieces indicated by shaded region 210, the corresponding fields 212 of the reverse bit-field contain the value 0 to indicate that those pieces are not needed to complete the download. Furthermore, because the P2P client program 204a has not downloaded the remaining portion of the content 202, the final four elements 214 of the reverse bit field 204 contain 1's to indicate that those pieces are still needed.

FIG. 2B shows the P2P client program 104a and the P2P offline program 114 at a second point in time. As compared to FIG. 2A, FIG. 2B shows that the P2P client program 104a is offline because the P2P client program 104a is no longer in communication with the P2P offline program 114. For example, the client machine 102 may have been shut down or placed in a standby operational mode. Based on the lack of communication from the P2P client program 104a, the P2P offline program 114 may determine that the P2P client program is no longer connected to the swarm 104 (see FIG. 1). As a result, the network device 112 may assume control over the download of the content 202. FIG. 2B shows that the network device has downloaded the remaining necessary pieces of the content 202, as stored in a local copy 208. Collectively, the pieces of 202 and 208 can be combined to form a complete download of the content 202. In an example embodiment, the P2P offline program may store a record of those pieces downloaded by the P2P offline program 114.

FIG. 2C shows the P2P client program 104a and the P2P offline program 114 at a final point in time. The P2P client program 104a is again communicating with the network device 112. As a result, the P2P offline program 114 synchronizes with the P2P client program 104c. Synchronizing may include transferring those pieces of the content downloaded by the P2P offline program 114 (see network device local copy 208) while the P2P client program 104a was offline.

An advantage of downloading the missing pieces by synchronizing with the network device 112, rather than the swarm 104, is that the connection between P2P client program 104a and the P2P offline program 114 may offer a higher bandwidth connection than the connection between P2P client program and the peers.

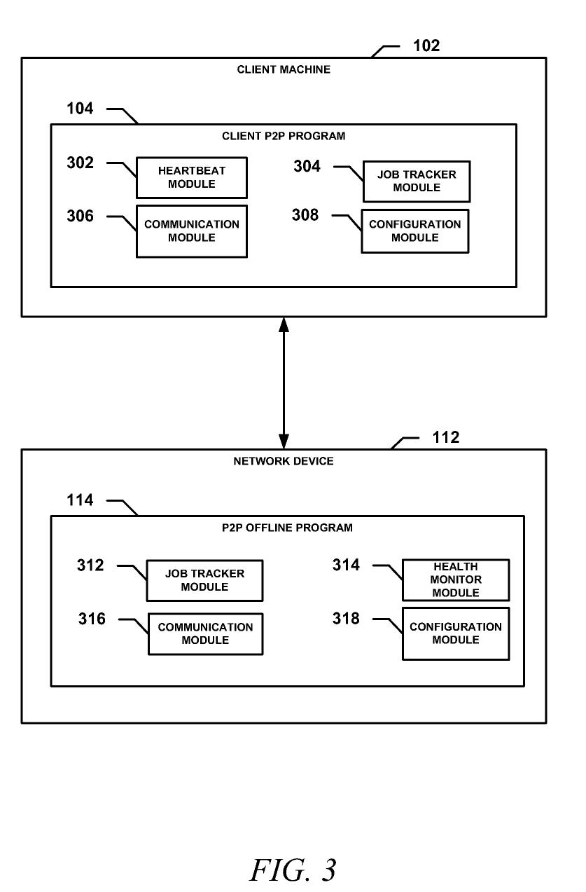

FIG. 3 is a block diagram showing the modules of the P2P client program 104a, running on a client machine 102, and the modules of the P2P offline program 112, running on the network device 112, according to an example embodiment.

The P2P client program 104a includes modules, including a heartbeat module 302, a job tracker module 304, a communication module 306, and a configuration module 308, to perform the operations of an example embodiment.

The heartbeat module 302 periodically transmits a heartbeat message to the P2P offline program 114. The heartbeat message may indicate that the client P2P program 104a is connected to the swarm 104. In this way, transmitting a heartbeat is an online event. Conversely, not transmitting a heartbeat message within a specified time period may be inferred to be an offline event.

The job tracker module 304 tracks the progress of downloading the content 162. The job tracker module 304 may record the specific pieces of the content already downloaded (see FIG. 2, shaded region 210). In an example embodiment, the job tracker module 304 may also record the pieces of the content that still needs to be received to complete the download. The progress information may be used to coordinate the download with the P2P offline program 114.

The communication module 306 receives and transmits messages from and to the network device 112. As will be explained below, the communication module 306 may, for example, transmit heartbeat messages and coordinate the progress of downloading the content 162. The communication module 306 also may receive pieces of content downloaded by the network device 112.

The configuration module 308 may configure operational aspects of the network device 112 that relate to offline downloading. In an example embodiment, the configuration module 308 may enable or turn on the functionality of the network device 112 that triggers the P2P offline program 114 so that the network device 112 continues downloading torrent files already started by the client P2P program 104a. Additionally, the configuration module 308 may disable the offline downloading functionality.

In addition to sending out configuration messages to the network device 112, the configuration module 308 also may configure aspects of the P2P client program 104a. For example, the client P2P program 104a may be configured to automatically enable the offline download feature of the network device 112 whenever the offline download feature is available. In an example embodiment, the configuration module 308 may allow an end user to set the configuration features of the client P2P program 104a via a graphical user interface.

The P2P offline program 114 includes a job tracker module 312, a health monitor module 314, a communication module 316, and a configuration module 318, according to an example embodiment.

The job tracker module 312 tracks the status of the downloads being performed by the client P2P program 104a. The status may identify the content being downloaded by the client P2P program 104a. In an example embodiment, a bit torrent file may identify the content being downloaded by the client P2P program 104a. Further, the status may include indication of the pieces of the content that the client P2P program 104a needs to complete the download. As explained above, the indication of the pieces of the content that the client P2P program 104a needs to complete the download may be represented by the reverse bit field 204. As the client P2P program 104a receives additional pieces of the content, the client-side job tracker module 312 may update the reverse bit field 204 to indicate that the received pieces are not needed to complete the download.

The health monitor module 314 monitors the client P2P program 104a to detect the occurrence of offline and online events. Depending on whether the health monitor module 314 detects an offline or online event, the P2P offline program 114 either may assume control over a download or synchronize received pieces of the download with the client P2P program 104a. In an example embodiment, the health monitor module 314 receives an online event in the form of periodic heartbeat messages transmitted from the client P2P program. If, after a threshold time period, the health monitor module 314 does not receive a heartbeat message from the client P2P program 104a, the health monitor module 314 may infer an offline event, and, as a result, will assume control over the downloads initiated by the client P2P program 104a. When the P2P offline program 114 assumes control over a download, the P2P offline program 114 is said to be in an active state. If the P2P offline program 114 is in the active state and receives a subsequent online event (e.g., a heartbeat message), the P2P offline program 114 synchronizes with the client P2P program 104a to transfer content downloaded by the network device 112 to the client P2P program 114.

The communication module 316 receives and transmits messages from and to the client machine 102. As will be explained below, the communication module 306 may, for example, receive heartbeat messages and status information about the content being downloaded by the client P2P program 104a. The communication module 306 also may receive pieces of content downloaded by the network device.

The configuration module 318 configures operational aspects of the network device 112 that relate to offline downloading. In an example embodiment, the configuration module 318 may enable or disable the functionality of the network device that triggers the P2P offline program 114 so that the network device 112 can continue downloading torrent files already started by the client P2P program 104a. In an example embodiment, the configuration module 318 configures the network device 112 responsive to configuration requests from the client P2P program 104a. In addition to configuring the network device 112 to enable or disable offline downloading, the configuration module 318 may also provide configuration information to the P2P client program 104a for visual display to an end-user.

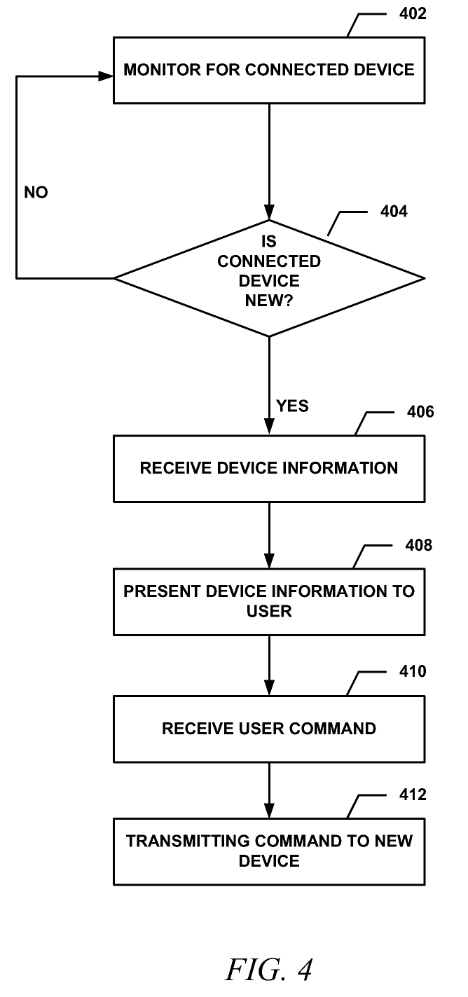

FIG. 4 is a flowchart illustrating an example method 400 of enabling a network device 112 to perform offline downloading.

Operation 402 involves monitoring for a new network device connected to the client machine 102. In an example embodiment, the client P2P program 104a monitors for a new network device by periodically polling a network device indicator (e.g., shared memory, register, operating system) for network devices attached to the client machine. In another example embodiment, the client P2P program 104a may monitor for a new network device by receiving a message, a signal, an event, or any other asynchronous indication that a network device is connected to the client machine 102.

Operation 404 involves determining whether a new network device is connected to the client machine 102 (see FIG. 1). In an example embodiment, the configuration module 308 may identify a new network device by comparing an identifier associated with a discovered network device and a list of identifiers of known network devices connected to the client P2P program 114. If there are no new network devices connected to the client machine, method 400 executes operation 402. Otherwise, if the discovered network device is a new to the client machine 102, the method 400 executes operation 406.

Operation 406 involves receiving information related to the network device attached to the client machine 102. The information received from the new network device may include network device content, a network device name, available functionality, configuration details, and other network device information. The network device content may include information about files stored in the storage device 116 (see FIG. 1). Functionality may include enabling offline downloading, synchronizing download content, and file management (e.g., file copy, move, delete).

Operation 408 involves presenting the network device information to an end-user. In an example embodiment, the client P2P program 104a may present the information of the network device in a graphical user interface. For example, the client P2P program 104a may display, within an explorer style window, the network device's name and an icon representing the network device. Responsive to selecting the network device icon, the client P2P program 104a may display the contents of the storage device 116 connected to the network device 112. The contents of the storage device 116 may include previously downloaded content, for example. Alternatively, responsive to a further user interaction (e.g., a right mouse click or interactions with a menu), the client P2P program 104a may display functionality provided by the network device 112. The functionality of the network device 112 may include enabling offline downloads, synchronizing content with the P2P client program 104a, management of content, and other similar actions.

Operation 408 involves receiving a user command related to the network device 112. In an example embodiment, the client P2P program 104a may receive a user request for the network device 112 to perform a supported function or to set a configuration value.

Operation 410 involves transmitting the user command to the network device 112. In an example embodiment, the client P2P program 104a may transmit a command to enable offline downloading, or to set a configuration value. In example embodiments, transmitting a request may include setting a device register or shared memory. In other example embodiments, the request is transmitted by a procedural call (e.g., local or remote) or as a message transmitted via a network protocol (e.g., TCP or IP).

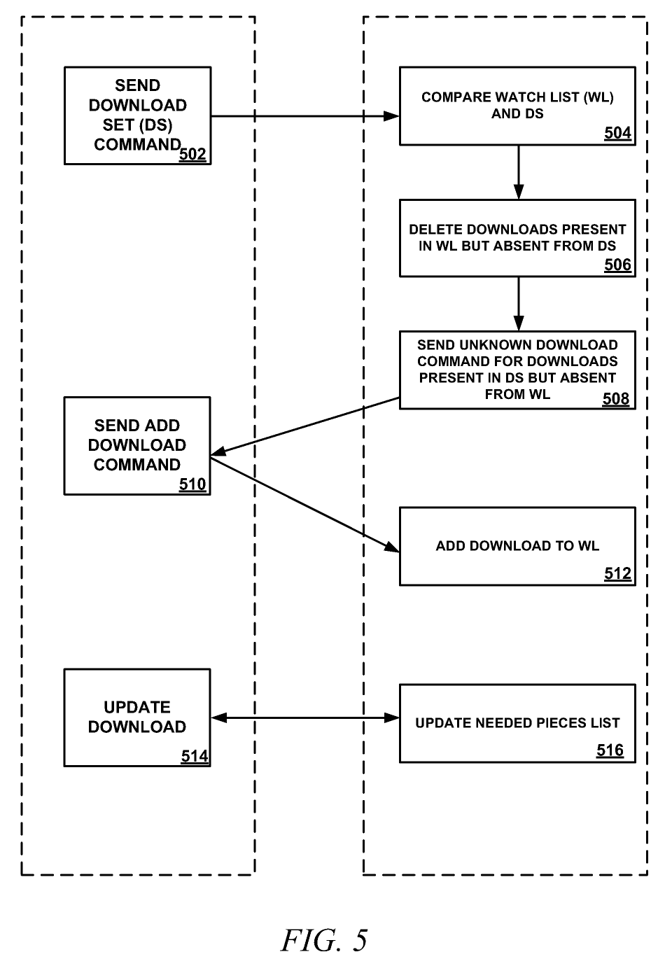

FIG. 5 is a flow diagram illustrating an example method 500 of updating the network device 112 with download status of content being downloaded by the client P2P program 104a.

Operation 502 involves the client P2P program 104a sending a download set to the P2P offline program 114. The download set identifies content currently being downloaded by the client P2P program 104a. The download set may include a list of hashes that the P2P client program 104a is currently downloading. In an example embodiment, the P2P client program 104a may update the network device 112 by sending the download set at a specified frequency (e.g., every 30 seconds).

Operation 504 involves comparing the download set received at operation 502 with a watch list. The watch list is a data structure stored by the offline P2P program 114 that lists content that the offline P2P program 114 has identified as being downloaded by the client P2P program 104a. If the offline P2P program 114 receives or infers an offline event, the offline P2P program 114 will assume control over the content downloads identified in the watch list. In an example embodiment, the watch list identifies content downloads by storing a list of hashes included in download sets previously sent by the client P2P program 104a.

Operation 506 involves deleting, from the watch list, the content downloads present in the watch list but absent from the download set. In an example embodiment, if a content download is not in the download set provided by the P2P client program 104a, the P2P offline program 114 may assume that the content download is no longer needed by the P2P client program 104a. For example, if the download completes or is cancelled by the end-user, the P2P client program 104a will not include the completed or cancelled content download in subsequent download sets sent to the offline P2P program 114. Alternatively, the P2P client program 104a may send an explicit command to remove a content download from the watch list.

Operation 508 involves sending an unknown download command to the P2P client program 104a responsive to determining that a content download is present in the download set but absent from the watch list. In an example embodiment, content downloads that are present in the download set but absent from the watch list may be assumed to be a download that was recently started by the P2P client program 104a. Alternatively, an example embodiment may send an explicit command to add a content download to the watch list rather than infer it from the download set.

Operation 510 involves the client P2P program 104a sending the offline P2P program 114 an add download command. In an example embodiment, the add download command may include the hash for the download and torrent data. Torrent data may include data defining the pieces of the downloaded needed by the P2P client program 104a. In an example embodiment, a reverse bit field 204 (see FIG. 2) may define the pieces of the download needed by the P2P client application 104a to complete the download. In other example embodiments, the pieces needed by the P2P client program 104a may be inferred from a bit torrent bit field. That is, the P2P offline program 114 may assume those pieces not yet downloaded are pieces needed by the P2P client program 104a. As such, the P2P offline program 114 may inverse the bit torrent bit field to infer the pieces needed by the P2P client program 104a.

Operation 512 involves adding the content download to the watch list. As described above, the watch list may include the hashes and download data of the content downloads that the P2P offline program 114 believes are being performed at the P2P client program 104a. In an example embodiment, the P2P offline program 114 may add an entry to the watch list that includes the hash and the download data corresponding to the content download.

Operation 514 involves the P2P client program 104a sending an update download command to the P2P off-line program 114. In an example embodiment, for each content download, the P2P client program 104a updates the offline P2P program 114 with a current set of pieces needed by P2P client program 104a to complete the content download. Specifying the pieces required, rather than those received, allows support for partial downloads (e.g., a subset of the files in a torrent selected for download by the user).

Operation 516 involves the P2P off-line program 114 updating the watch list to include an updated list of the pieces the client P2P program 104a needs to complete the download. In an example embodiment, the P2P off-line program 114 receives a reverse bit field that indicates the pieces of the download needed by the P2P client program 104a. Responsive to receiving the update message, the P2P off-line program 114 may update the watch list.

Additionally, at operation 516, the P2P off-line program 114 may send, to the P2P client program 104a, a set of the pieces downloaded by the P2P off-line program 114 while the client P2P program 104a was offline. This allows the client P2P program 104a and the offline P2P program to coordinate the download of content that is partially downloaded by the client P2P program 104a and the offline P2P program 114 (e.g., when the client P2P program 104a was offline).

Note that FIG. 5 shows operations 514 and 516 are not connected to the other operations. This illustrates that these two operations may be performed independent of the other operations. Furthermore, the P2P client program 104a may periodically update the network device 112 on the status of the downloads.

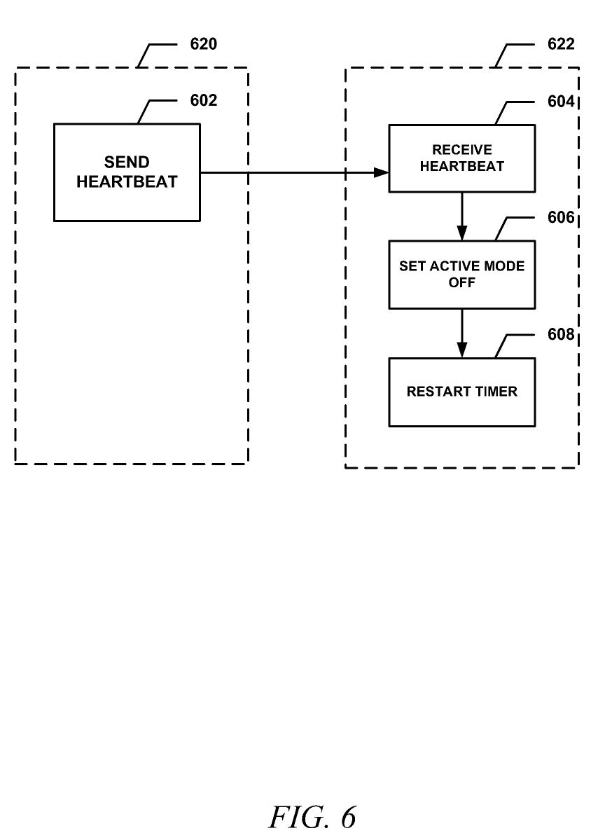

FIG. 6 is a flowchart illustrating an example method 600 of sending an online event from a P2P client program 104a to a P2P offline program 114.

Operation 602 involves the P2P client program 104 sending a heartbeat message to the P2P off-line program 114. The heartbeat message indicates that the P2P client program 104a is connected to the swarm. The heartbeat message, in some embodiments, may be communicated via any number of techniques, such as remote procedural calls, HTTP messages, SOAP messages, operating system constructs (e.g., signals, sockets, files, shared memory), or similar interprocess communication.

Operation 604 involves the P2P off-line program 114 receiving the heartbeat message sent by the P2P client program 104a.

Operation 606 involves the P2P off-line program 114 setting the active mode off. The active mode indicates whether the P2P off-line program 114 should assume control of the content downloads initiated by the P2P client program 104a. In particular, when the active mode is on, the P2P offline program 114 assumes control of downloading the content listed in the watch list. Furthermore, when the active mode is off, the client P2P program 104a will assume control over downloading the content.

Operation 608 involves restarting a timer. The timer is used to determine whether the offline P2P program 114 should be place in active mode or not and, as a result, assume control over downloading. More specifically, as will be described below, the timer may be used to determine if an offline event has occurred (e.g., whether the P2P client program 104a is disconnected from the swarm 104). In such a case, the network device 112 may not receive a heartbeat message from the client device 102 for some period of time. In an example embodiment, the timer may be a hardware or software timer or a counter that the offline P2P program increments at a specified frequency (e.g., every 30 seconds).

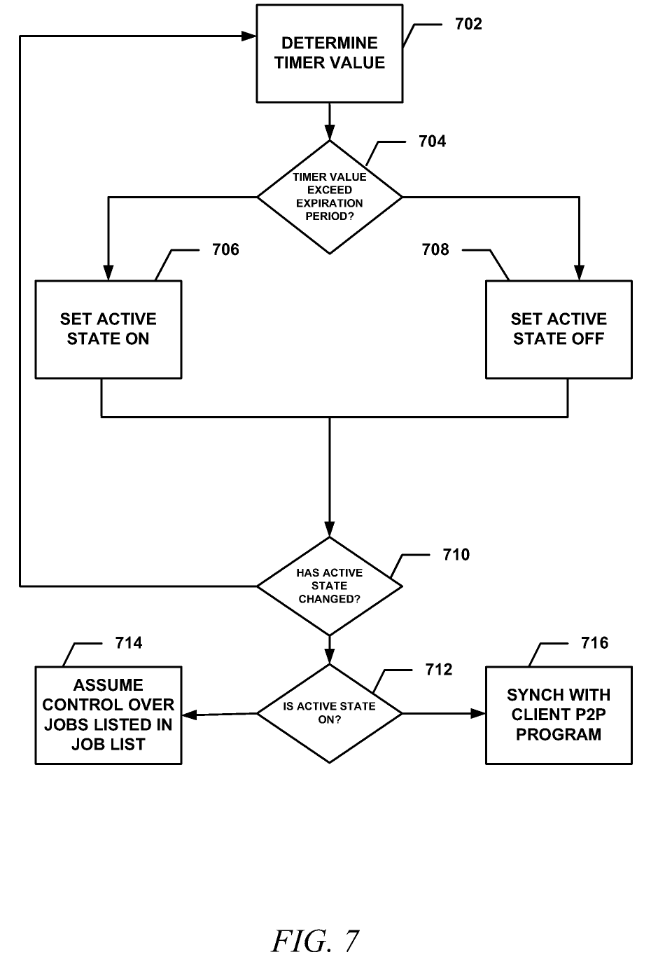

FIG. 7 is a flowchart that illustrates an example method 700 of determining a download action for the network device 112 based on the active mode.

Operation 702 involves determining the current value of the timer. As described above, the timer measures the time period since the offline P2P program 114 last received a heartbeat message. In an example embodiment, the timer may be a hardware or software timer or a counter that the offline P2P program increments at a specified frequency (e.g., every 30 seconds).

Operation 704 involves determining whether the timer value counter exceeds an expiration period. If the timer value exceeds the expiration period, the method 700 continues to operation 706. Otherwise, the method 700 continues to operation 708.

Operation 706 involves setting the active mode on. Having the active mode set on indicates that the network device 112 should assume control over the content downloads initiated by the client P2P program 104a. In an example embodiment, the offline P2P program 114 will become the downloading peer for the content downloads listed in the watch list. The offline P2P downloader 114 may request downloads of those pieces of the content specified by the reverse bit field 204, for example, or other indication of pieces needed to complete the download.

Operation 708 involves setting the active mode off. Having the active mode set off indicates that the client device 102 should assume control over the content download.

Operation 710 involves determining whether the active mode has changed. If the offline P2P program 114 determines that the active mode has not changed, method 700 continues to operation 702. Otherwise, method 700 continues to operation 712.

Operation 712 involves determining whether the active mode is on. If the active mode is on, method 700 continues to operation 714. Otherwise, method 700 continues to operation 716.

Operation 714 involves assuming control over the content downloads of the client P2P program 104a. The offline P2P program 114 may assume control of the content downloads listed in the watch list by serving as the downloading peer for the content. Further, the offline P2P program 114 may download only those pieces of the content needed by the client P2P program 104a (e.g., as listed by a reverse bit field 204 or other data structure indicating needed pieces).

Operation 716 involves synchronizing with the P2P client program 104a. Synchronizing with the P2P client program 104a may include coordinating the completion of the content download by downloading the remaining pieces of the content from the network device 112 and the swarm 104. For example, the offline P2P program 114 may communicate those pieces downloaded by the network device while the client P2P program 104a was offline. Those pieces not specified by offline P2P program 114 and not yet stored by the client P2P program 104a may be received from the swarm 104. Because the communication path between the client device 102 and the network device 112 typically has higher bandwidth, the client P2P program 104a may improve downloading performance, as compared to downloading completely from the swarm 104.

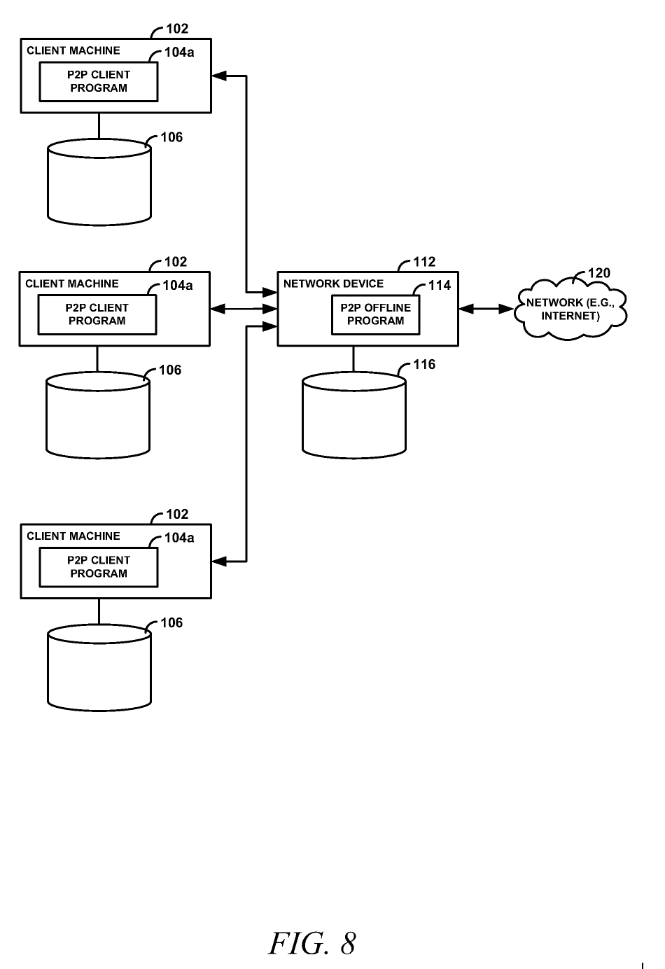

FIG. 8 is a block diagram illustrating an example embodiment of multiple client machines 102 communicating over the network 120 via the networking device 112 to download content 202 stored in data storage 106. In certain example embodiments, a user may be executing multiple copies of the P2P client program 104a, whether on a single client machine 102 or on separate client machines 102. It is conceivable that with multiple instances of the P2P client program 104a executing, different content may be in the process of being downloaded by each instance. If any or all of the multiple copies of the P2P client program 104a are no longer in communication with the networking device 112 because the particular instance or instances of the P2P client program 104a have been taken offline, the networking device 112 may be rendered useless or ineffective as the networking device 112 may have to continually swap torrent sets in an attempt to perform offline downloading for the one or more offline P2P client programs 104a.

In an example embodiment, a solution for handling conflicts caused by multiple P2P client programs 104a executing on the same client machine 102 or on separate client machines 102 is achieved by enabling the networking device 112 to support multiple concurrent users. The networking device 112 may maintain separate torrent sets for each user. Each copy of the P2P client program 104a may include an identifier field, such as a “vuse_id” field, when sending a request to the networking device 112 to assume control of the downloading of content. In an example embodiment, the P2P client program 104a and the offline P2P client program 114 may always use the same identifier between calls and sessions. In another example embodiment, the identifier may be unique per P2P client program 104a installation, whether on the same client machine 102 or on multiple client machines 102.

In a further example embodiment, in certain circumstances, a P2P client program 104a may be in the process of downloading content specified by one or more torrent files when the P2P client program 104a is re-installed. In an example embodiment, the P2P client program 104a may be re-installed as a result of an update applied to the P2P client program 104a. When the P2P client program 104a is re-installed, the download set maintained by the old version of the P2P client program 104a may be erased or otherwise be inaccessible. However, the old instance of the P2P client program 104a may still be known to the networking device 112, and the networking device 112 may continue to download torrents that are now inaccessible or whose data may never be “collected.” To rectify this scenario, the networking device 112 may have a manual delete option to delete out-of-date files.

### Modules, Components and Logic

Certain embodiments are described herein as including logic or a number of components, modules, or mechanisms. A component or module is a non-transitory and tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein.

In various embodiments, a component or a module may be implemented mechanically or electronically. For example, a component or a module may comprise dedicated circuitry or logic that is permanently configured (e.g., as a special-purpose processor) to perform certain operations. A component or a module also may comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software) may be driven by cost and time considerations.

Accordingly, the term “component” or “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components or modules are temporarily configured (e.g., programmed), each of the components or modules need not be configured or instantiated at any one instance in time. For example, where the components or modules comprise a general-purpose processor configured using software, the general-purpose processor may be configured as respective different components at different times. Software may accordingly configure a processor, for example, to constitute a particular component or module at one instance of time and to constitute a different component or module at a different instance of time.

Components or modules can provide information to, and receive information from, other components or modules. Accordingly, the described components may be regarded as being communicatively coupled. Where multiple of such components or modules exist contemporaneously, communications may be achieved through signal transmission (e.g., over appropriate circuits and buses) that connect the components or modules. In embodiments in which multiple components or modules are configured or instantiated at different times, communications between such components or modules may be achieved, for example, through the storage and retrieval of information in memory structures to which the multiple components or modules have access. For example, one component or module may perform an operation, and store the output of that operation in a memory device to which it is communicatively coupled. A further component or module may then, at a later time, access the memory device to retrieve and process the stored output. Components or modules may also initiate communications with input or output devices, and can operate on a resource (e.g., a collection of information).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination permanently and temporarily configured hardware may be a design choice. Below are set out hardware (e.g., machine) and software architectures that may be deployed, in various example embodiments.

### Example Machine Architecture and Machine-Readable Medium

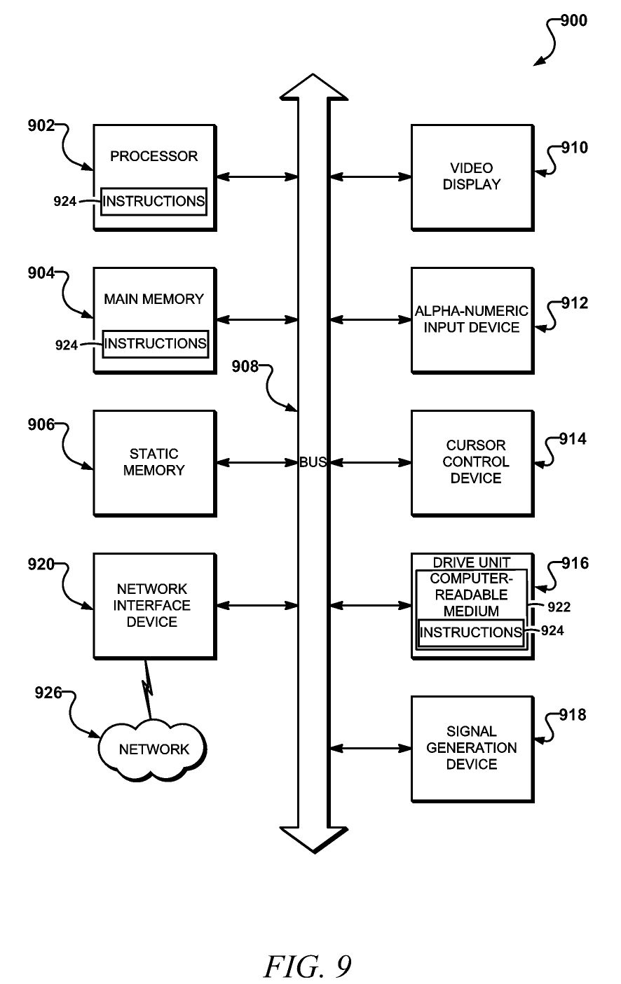

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine 102 in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes at least one processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 820.

### Machine-Readable Medium

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmission Medium

The software 924 may further be transmitted or received over a communications network 926 using a transmission medium. The software 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible medium to facilitate communication of such software.

### Example Three-Tier Software Architecture

In some embodiments, the described methods may be implemented using one a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules, or processes that govern the software as a whole. A third, storage tier, may be a persistent storage medium, or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology, or, a variety of technologies. The example three-tier architecture, and the technologies through which it is implemented, may be realized on one or more computer systems operating, for example, as a standalone system, or organized in a server-client, peer-to-peer, distributed or so some other suitable configuration. Further, these three tiers may be distributed between more than one computer systems as various components.

### Components

Example embodiments may include the above described tiers, and processes or operations about constituting these tiers may be implemented as components. Common to many of these components is the ability to generate, use, and manipulate data. The components, and the functionality associated with each, may form part of standalone, client, server, or peer computer systems. The various components may be implemented by a computer system on an as-needed basis. These components may include software written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique.

Software for these components may further enable communicative coupling to other components (e.g., via various Application Programming interfaces (APIs)), and may be compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may form part of a first computer system that is remotely located from a second computer system containing a logic component (e.g., a logic tier). These first and second computer systems may be configured in a standalone, server-client, peer-to-peer, or some other suitable configuration. Software for the components may be written using the above described object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

### A System of Transmission Between a Server and Client

Example embodiments may use the OSI model or TCP/IP protocol stack model for defining the protocols used by a network to transmit data. In applying these models, a system of data transmission between a server and client, or between peer computer systems may for example include five layers comprising: an application layer, a transport layer, a network layer, a data link layer, and a physical layer. In the case of software, for instantiating or configuring components, having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method to facilitate peer-to-peer networking, the computer-implemented method comprising:
communicating a download set to a network device, the download set identifying content being downloaded by a client program;
responsive to an offline event indicating that the client program is not downloading the content, transmitting to the network device an online event indicating the client program is resuming the downloading of the content; and
synchronizing the client program with the network device to complete downloading of the content identified by the download set.

2. The computer-implemented method of claim 1, further comprising communicating, to the network device, portions of the content required to complete the download of the content.

3. The computer-implemented method of claim 2, wherein the portions of the content required to complete the download of the content are communicated to the network device at a predetermined time interval.

4. The computer-implemented method of claim 1, wherein the communicating includes transmitting a reverse bit field to the network device, the reverse bit field containing elements mapping to pieces of the content being downloaded, an element having a first value based on a corresponding piece of the content having been downloaded, and the element having a second value based on the corresponding piece of the content not having been downloaded.

5. The computer-implemented method of claim 1, wherein the synchronizing including receiving portions of the content downloaded by the network during a period of time where the client program was offline.

6. The computer-implemented method of claim 1, further comprising:
monitoring for connection information related to the network device; and
transmitting a command to the network device to enable offline downloading.

7. A computer-implemented method to facilitate peer-to-peer networking, the computer-implemented method comprising:
receiving a download set from a client program, the download set identifying content being downloaded by the client program;
detecting an offline event indicating that the client program is not downloading the content;
based on the detection of the offline event, assuming control over downloading the content at a network device; and
storing portions of the downloaded content at a storage device connected to a network device.

8. The computer-implemented method of claim 7, further comprising:
detecting an online event indicating the client program is downloading the content; and
synchronizing portions of content downloaded by the network device with the client program.

9. The computer-implemented method of claim 7, wherein the synchronizing includes updating portions of the content needed by the client program and transmitting portions downloaded by the network device to the client device.

10. The computer-implemented method of claim 7, wherein the detecting of the offline event comprises:
starting a timer to measure an amount of time elapsed from a most recent communication with the client program;
determining that a value of the timer exceeds an expiration period;
based on the timer exceeding the expiration period, the network device assuming control over downloading the content; and
based on the timer not exceeding the expiration period, the network device continuing to wait for a communication from the client program.

11. The computer-implemented method of claim 7, further comprising receiving a reverse bit field from the client program, the reverse bit field identifying portions of the content required to complete the download of the content.

12. The computer-implemented method of claim 7, further comprising:
comparing the received download set with a watch list stored at the network device, the watch list containing a list of content being downloaded by the client program;
based on the comparing, deleting a first content download present in the watch list and absent from the received download set;
based on the comparing, transmitting an unknown download command to the client program in response to determining a second content download present in the received download set and absent from the watch list;
responsive to the unknown download command, receiving information about the second content download from the client program; and
adding the second content download to the watch list.

13. A networking device to facilitate peer-to-peer networking, the networking device comprising:
a processor-implemented job tracker module configured to track a status of a content download being performed by a client program in communication with the networking device;
a processor-implemented health monitor module configured to monitor the client program to detect online and offline events indicating that the client program is respectively online and offline with respect to a network; and
a processor-implemented configuration module configured to enable the networking device to assume control of the content download being performed by the client program based on the client program being offline.

14. The networking device of claim 13, further comprising a processor-implemented communication module configured to receive and transmit messages to the client machine.

15. The networking device of claim 14, wherein the messages include a status message containing the status of the content download and a heartbeat message containing the online event received from the client program.

16. The networking device of claim 13, further comprising a watch list configured to store a list of content being downloaded by the client program, the watch list identifying the content to be downloaded by the networking device based on the client program being offline.

17. The networking device of claim 13, further comprising a timer configured to measure an amount of time elapsed from a most recent communication with the client program, wherein the processor-implemented configuration module enables the networking device to assume control of the content download being performed by the client program based on the processor-implemented health monitor module failing to detect an online event from the client program prior to a value of the timer being equal to an expiration period, and wherein the processor-implemented health monitor module continues to monitor the client program based on the process-implemented health monitor module detecting the online event prior to the time value being equal to the expiration period.

18. A system for facilitating peer-to-peer networking, the system comprising:
a memory; and
a processor, coupled to the memory, configured to execute a set of instructions stored in the memory to:
communicate a download set to a network device, the download set identifying content being downloaded by a client program;
responsive to an offline event indicating that the client program is not downloading the content, transmit to the network device an online event indicating the client program is resuming the downloading of the content; and
synchronize the client program with the network device to complete downloading of the content identified by the download set.

19. The system of claim 18, wherein the processor is further configured to communicate, to the network device, portions of the content required to complete the download of the content.

20. The system of claim 19, wherein the portions of the content required to complete the download of the content are communicated to the network device at a predetermined time interval.

21. The system of claim 18, wherein the communicate a download set to a network device includes transmit a reverse bit field to the network device, the reverse bit field containing elements mapping to pieces of the content being downloaded, an element having a first value based on a corresponding piece of the content having been downloaded, and the element having a second value based on the corresponding piece of the content not having been downloaded.

22. The system of claim 18, wherein the synchronize with the network device includes receive portions of the content downloaded by the network during a period of time where the client program was offline.

23. The system of claim 18, wherein the processor is further configured to:
monitor for connection information related to the network device; and
transmit a command to the network device to enable offline downloading.

24. A non-transitory computer-readable storage medium storing a set of instructions that, when executed by a processor, cause the processor to perform operations comprising:
communicating a download set to a network device, the download set identifying content being downloaded by a client program;
responsive to an offline event indicating that the client program is not downloading the content, transmitting to the network device an online event indicating the client program is resuming the downloading of the content; and
synchronizing the client program with the network device to complete downloading of the content identified by the download set.

25. The non-transitory computer-readable storage medium of claim 24, further comprising communicating, to the network device, portions of the content required to complete the download of the content.

26. The non-transitory computer-readable storage medium of claim 25, wherein the portions of the content required to complete the download of the content are communicated to the network device at a predetermined time interval.

27. The non-transitory computer-readable storage medium of claim 24, wherein the communicating includes transmitting a reverse bit field to the network device, the reverse bit field containing elements mapping to pieces of the content being downloaded, an element having a first value based on a corresponding piece of the content having been downloaded, and the element having a second value based on the corresponding piece of the content not having been downloaded.

28. The non-transitory computer-readable storage medium of claim 24, wherein the synchronizing including receiving portions of the content downloaded by the network during a period of time where the client program was offline.

29. The non-transitory computer-readable storage medium of claim 24, further comprising:
monitoring for connection information related to the network device; and
transmitting a command to the network device to enable offline downloading.

30. A non-transitory computer-readable storage medium storing a set of instructions that, when executed by a processor, causes the processor to perform operations comprising:
receiving a download set from a client program, the download set identifying content being downloaded by the client program;
detecting an offline event indicating that the client program is not downloading the content;
based on the detection of the offline event, assuming control over downloading the content at a network device; and
storing portions of the downloaded content at a storage device connected to a network device.

31. The computer-implemented method of claim 30, further comprising:
detecting an online event indicating the client program is downloading the content; and
synchronizing portions of content downloaded by the network device with the client program.

32. The computer-implemented method of claim 30, wherein the synchronizing includes updating portions of the content needed by the client program and transmitting portions downloaded by the network device to the client device.

33. The computer-implemented method of claim 30, wherein the detecting an offline event comprises:
starting a timer to measure an amount of time elapsed from a most recent communication with the client program;
determining that a value of the timer exceeds an expiration period;
based on the timer exceeding the expiration period, the network device assuming control over downloading the content; and
based on the timer not exceeding the expiration period, the network device continuing to wait for a communication from the client program.

34. The computer-implemented method of claim 30, further comprising receiving a reverse bit field from the client program, the reverse bit field identifying portions of the content required to complete the download of the content.

35. The computer-implemented method of claim 30, further comprising:
comparing the received download set with a watch list stored at the network device, the watch list containing a list of content being downloaded by the client program;
based on the comparing, deleting a first content download present in the watch list and absent from the received download set;
based on the comparing, transmitting an unknown download command to the client program in response to determining a second content download present in the received download set and absent from the watch list;
responsive to the unknown download command, receiving information about the second content download from the client program; and
adding the second content download to the watch list.
